(19) United States
(12) Patent Application Publication
(10) Pub. No.: US 2013/0234939 A1
(43) Pub. Date: Sep. 12, 2013

(54) Keyboard Having a Key-In Area Integrated with a Touch Sensor Device and a Method Thereof

(71) Applicants: WEN-CHIN LEE, (US); POLOSTAR TECHNOLOGY CORPORATION, New Taipei City (TW)

(72) Inventor: WEN-CHIN LEE, New Taipei City (TW)

(73) Assignees: POLOSTAR TECHNOLOGY CORPORATION, NEW TAIPEI CITY (TW); WEN-CHIN LEE, New Taipei City (TW)

(21) Appl. No.: 13/686,857

(22) Filed: Nov. 27, 2012

(30) Foreign Application Priority Data
Mar. 8, 2012 (TW) 101107787

(51) Int. Cl. G06F 3/02

(52) U.S. Cl. CPC G06F 3/0213
USPC 345/158

(57) ABSTRACT

The present invention is related to a keyboard having a key-in area integrated with a touch sensor device and a method thereof by providing at least one touch sensor device at a key location within the key-in area of a keyboard main body, and electrically connecting the touch sensor device to the keyboard main body to transmit a signal via the keyboard main body. With the method of integrating a key-in area of a keyboard with a touch sensor device provided by the present invention, the keyboard and the pointing device can be integrated altogether as one such that the operation and control efficiency thereof is advantageously enhanced and is adapted for various application environments and practical usages.

### (a) TECHNICAL FIELD OF THE INVENTION

The present invention is related to a keyboard having a key-in area integrated with a touch sensor device and a method thereof, in particular, to a keyboard having a touch sensor device integrated with keys of the keyboard such that the keyboard includes the operational functions of a keyboard and a pointing device.

### (b) DESCRIPTION OF THE PRIOR ART

Currently, keyboards and pointing devices, including such as mice or pointing devices, are the main input devices used for communications with computer equipment by most users and among which, the keyboards are mainly provided for users to input characters whereas the pointing devices are provided for users to control the cursor in various applications and software to have different pointing operations including such as pointer movement, selection and drag.

As there are more and more computer equipments, including such as notebook computers, Tablet PCs and intelligent mobile phones, are equipped with a HDMI connection interface such that the video and audio signals of the computer equipment can be transmitted to an externally connected larger screens in such as a conference or living rooms via the HDMI interface, which also allows such large screens to be used as computer monitors.

However, currently, most users are still being limited to the use of existing wireless keyboards or mice for characters inputs or pointer controls during the computer operations, which is, in fact, not suitable to such applications and environments as they pose difficulties in the practical operations. Although there have been some wireless keyboards integrated with touch sensor devices or track-ball devices external to the key-in areas of the keyboards introduced to the market, they are still of a design that is bulky in size, difficult for controls and operations thereof and is inconvenient to storage or carrying.

There is certainly a need to improve the above-mentioned drawbacks associated with the current keyboards and pointing devices as well as their operations and controls such that users are able to conveniently and promptly operate such devices and their functions.

### SUMMARY OF THE INVENTION

In view of the above-mentioned drawbacks associated the known arts, a primary objective of the present invention is to integrate a pointing device into a keyboard such that an user can conveniently and promptly operate or control the functions of the keyboard and the pointing device at the same time and such that it can be adapted for different keyboards of various sizes and is suitable to all kinds of different application environments.

To achieve the above-mentioned objective, the present invention provides a method of integrating a key-in area of a keyboard with a touch sensor device, comprising the steps of providing at least one touch sensor device at a key location within said key-in area of a keyboard main body; and electrically connecting said touch sensor device to said keyboard main body to transmit a signal via said keyboard main body.

Another objective of the present invention is to provide a keyboard having a key-in area integrated with a touch sensor device, comprising a keyboard main body, a plurality of keys and at least one touch sensor device; and wherein the at least one touch sensor device is provided within the key-in area of the keyboard main body.

A thin-film circuit module and a device circuit module are provided at an internal of the keyboard main body; and wherein the thin-film circuit module is electrically connected to the device circuit module. The plurality of keys, are provided within the key-in area of the keyboard main body and on top of the thin-film circuit module such that a downward press exerted by an external force on each one of the keys touches a matrix circuitry of the thin-film circuit module to correspondingly generate a key signal sent to the device circuit module.

The touch sensor device comprises a plastic housing and a touch signal detector and is provided within the key-in area of the keyboard main body; and wherein the touch signal detector is electrically connected to the thin-film circuit module or the device circuit module.

The design and structural configuration of the present invention allow users to conveniently and promptly operate or control the keyboard and the pointing device including their independent functions as well as their combined functions at the same time.

In addition, the device circuit module further comprises a keyboard control circuit and a connection interface for connecting with computer equipment; and wherein the connection interface can be a wired or wireless connection interface.

### BRIEF DESCRIPTION OF THE DRAWINGS

FIG. 1 is a perspective view of the preferred embodiment of the present invention;

FIG. 2 is a top view of the preferred embodiment of the present invention;

FIG. 3 is an illustration showing locations of the modules of the preferred embodiment of the present invention;

FIG. 4 is a perspective view of the touch sensor device of the preferred embodiment of the present invention;

FIG. 5 is a cross sectional view of the touch sensor device of the preferred embodiment of the present invention; and

FIG. 6 to FIG. 9 are illustrations showing different locations for the configuration of the touch sensor device of preferred embodiment of the present invention.

### DETAILED DESCRIPTION OF THE PREFERRED EMBODIMENTS

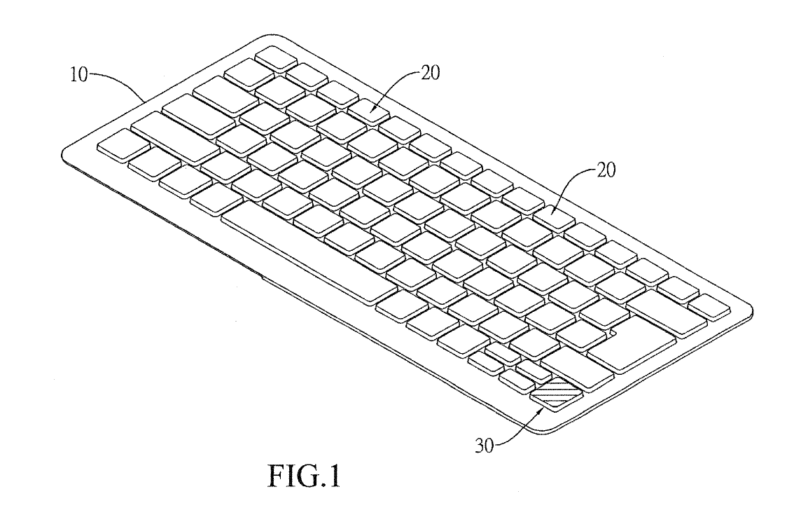

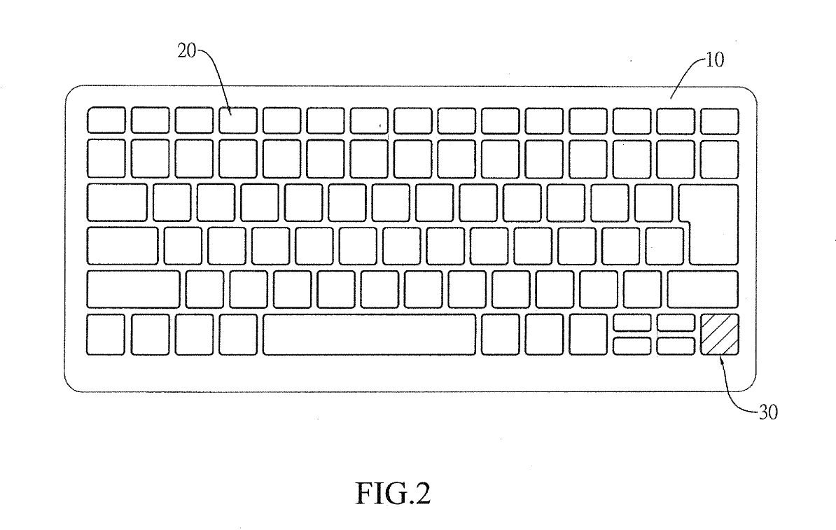

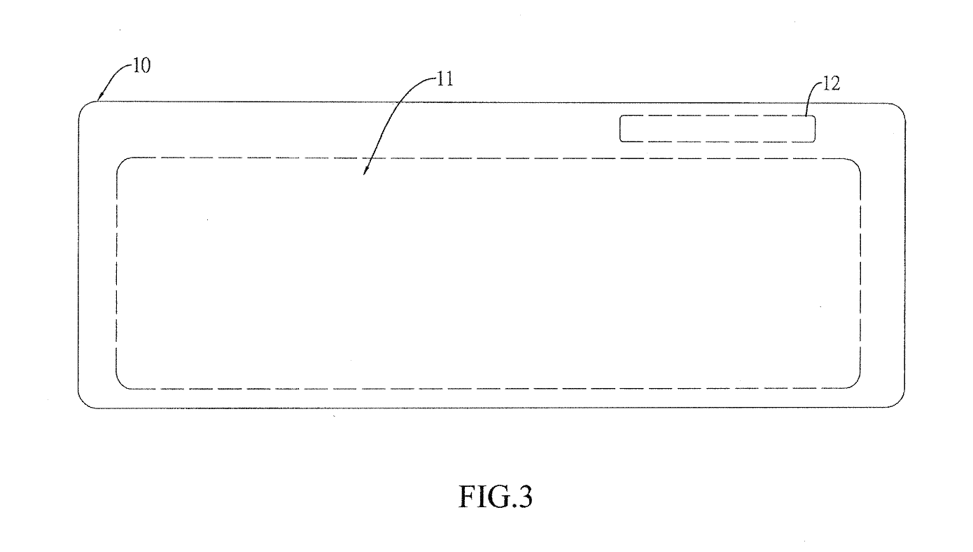

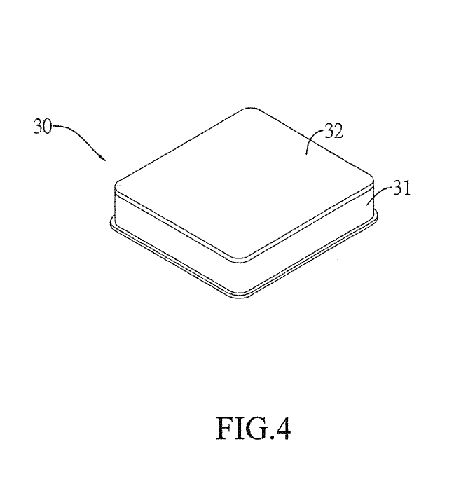

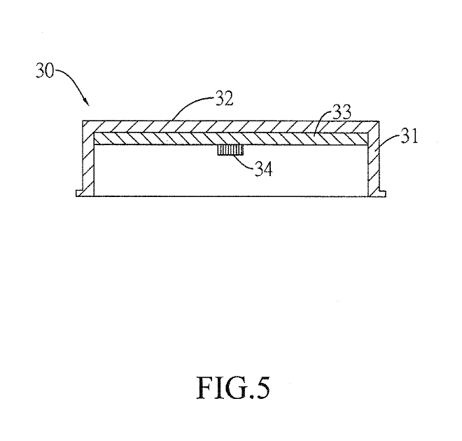

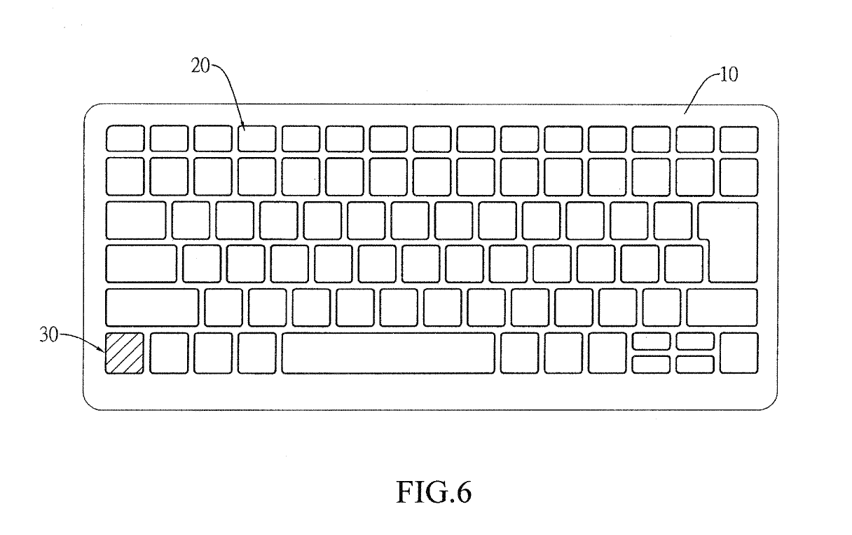

In accordance with the accompanied drawings disclosed, FIG. 1 is a perspective view of the present invention; FIG. 2 is a top view of the preferred embodiment of the present invention; FIG. 3 is an illustration showing locations of the modules of the preferred embodiment of the present invention; FIG. 4 is a perspective view of the touch sensor device of the preferred embodiment of the present invention; FIG. 5 is a cross sectional view of the touch sensor device of the preferred embodiment of the present invention; and FIG. 6 to FIG. 9 are illustrations showing different locations for the configuration of the touch sensor device of preferred embodiment of the present invention.

As shown in FIG. 1 and FIG. 2, the present invention provides a method of integrating a key-in area of a keyboard with a touch sensor device, comprising a keyboard main body 10, a plurality of keys 20 and a touch sensor device 30. Said method comprises the steps of providing at least one touch sensor device at a key location within the key-in area of a keyboard main body; and electrically connecting the touch sensor device to the keyboard main body to transmit a signal via the keyboard main body.

As shown in FIG. 3, the keyboard main body 10 further comprises a thin-film circuit module 11 and a device circuit module 2, and the thin-film circuit module 11 is electrically connected to the device circuit module 12. In addition, the thin-film circuit module 11 comprises a key matrix circuitry and a control circuitry for keyboard.

As shown in FIG. 1 and FIG. 3, the plurality of keys 20 of the keyboard main body 10 are provided within the key-in area thereof and are provided on top of the thin-film circuit module 11 such that a downward press exerted by an external force on each one of the keys 20 touches a matrix circuitry of the thin-film circuit module 11 such that the thin-film circuit module 11 correspondingly generates a key signal to be sent to the device circuit module 12. The device circuit module 12 further comprises a wired or wireless connection interface to electrically connect to and communicate with computer equipment.

As shown in 4 and FIG. 5, the touch sensor device 30 comprises a plastic housing 31, a touch signal detecting zone 32, a touch signal detector 33 and a connector 34. The touch sensor device 30 is provided at any one of the locations of the keys 20 within the key-in area of the keyboard main body 10 and is provided on top of the thin-film circuit module 11. The touch signal detector 33 of the touch sensor device 30 is received within the plastic housing 31 to capture the signal from the touch signal detecting zone 32 generated by an user and is electrically connected to the device circuit module 12 via the connector 34.

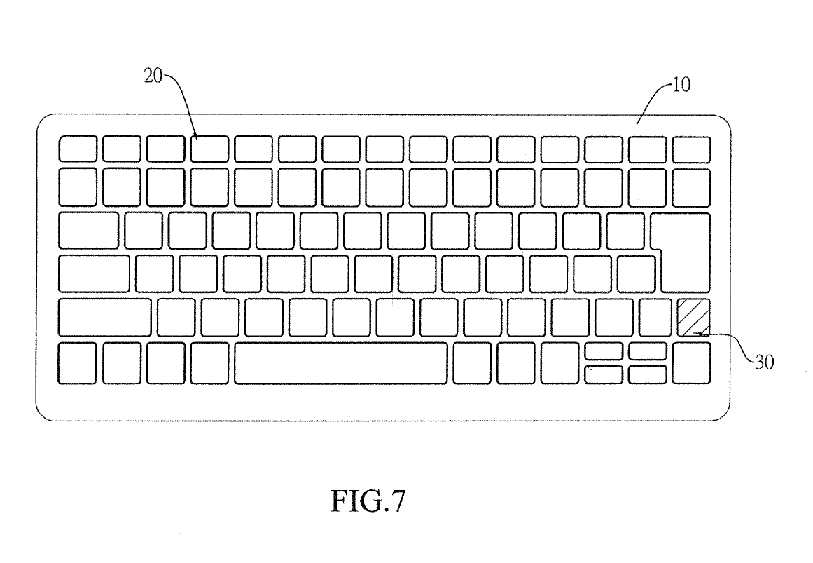

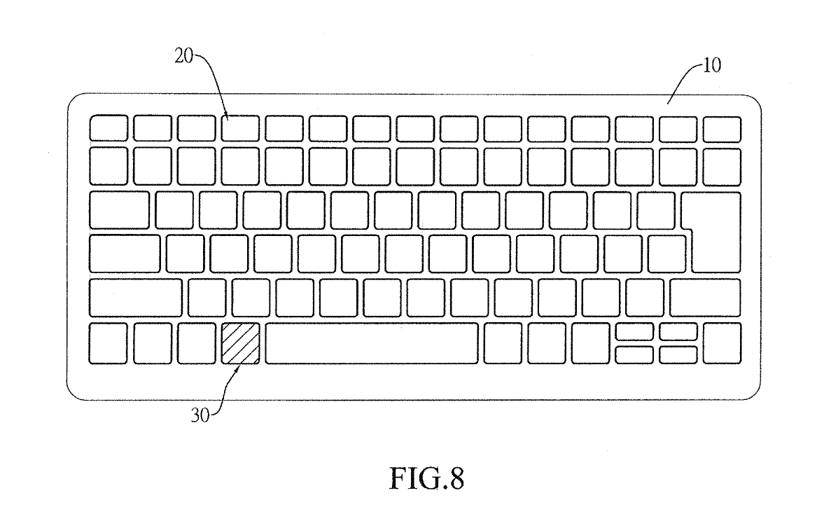

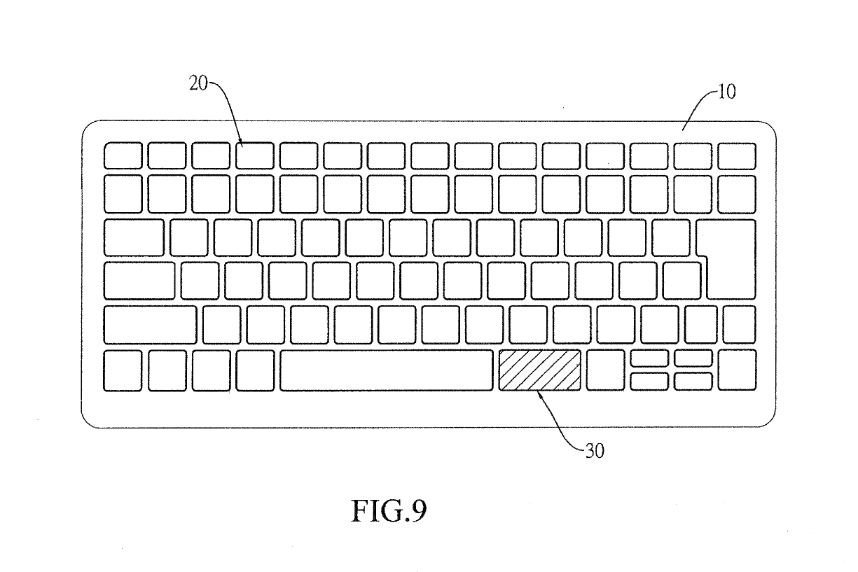

In view of the above descriptions along with the accompanied drawings, the present invention advantageously integrates the touch sensor device 30 into the key-in area of the keyboard main body 10 such that the overall size of the keyboard is not increased while the touch sensor device 30 can be designed and arranged to be at any location in the key-in area in order to satisfy the needs and operation usages of different users. As an illustrative example shown by FIG. 2 and FIG. 7, the touch sensor device 30 can be provided or arranged at a lower right corner location and a right center location of the key-in area such that it is adapted for the operations of right-handed users. In addition, as another illustrative example shown by FIG. 6 and FIG. 8, the touch sensor device 30 can be provided or arranged at a lower left corner location or a location left of the space-key such that it is adapted for the operations of left-handed users. Furthermore, still as another illustrative example shown by FIG. 9, the touch sensor device 30 can be designed and provided at a center location of the space-key in the key-in area such that it is adapted for the operations of most common users. Accordingly, it shall be understood that for the present invention, the touch sensor device 30 can be provided and arranged at different locations depending upon the design needs and requirements of various applications and usages.

In comparison to the known keyboards, the present invention provides a keyboard having both the functions of keyboard inputs and pointer controls integrated altogether as one, such that users can easily and conveniently use or operate the independent functions of the keyboard and the pointer as well as the combined functions thereof, and such that the efficiency of the operation and control of the device are advantageously enhanced and are more suited to practical usages with a greater portability.

What is claimed is:

1. A method of integrating a key-in area of a keyboard with a touch sensor device, comprising the steps of: providing at least one touch sensor device at a key location within said key-in area of a keyboard main body; and electrically connecting said touch sensor device to said keyboard main body to transmit a signal via said keyboard main body.

2. The method of integrating a key-in area of a keyboard with a touch sensor device according to claim 1, wherein an internal of said keyboard main body further comprises a thin-film circuit module and a device circuit module; said thin-film circuit module is electrically connected to said device circuit module; a plurality of keys are within said key-in area of said keyboard main body and are provided on top of said thin-film circuit module such that a downward press exerted by an external force on each one of said keys touches a matrix circuitry of said thin-film circuit module to correspondingly generate a key signal to be sent to said device circuit module; and said at least one touch sensor device further comprises a plastic housing and a touch signal detector; said touch signal detector is received within said plastic housing and is electrically connected to said thin-film circuit module or said device circuit module.

3. A keyboard having a key-in area integrated with a touch sensor device, comprising:
a keyboard main body, having a thin-film circuit module and a device circuit module provided therein; wherein said thin-film circuit module is electrically connected to said device circuit module;
a plurality of keys, provided within said key-in area of said keyboard main body and on top of said thin-film circuit module, such that a downward press exerted by an external force on each one of said keys touches a matrix circuitry of said thin-film circuit module to correspondingly generate a key signal to be sent to said device circuit module; and
at least one touch sensor device, comprising a plastic housing and a touch signal detector; wherein said touch signal detector is received within said plastic housing and is electrically connected to said device circuit module.

4. The keyboard having a key-in area integrated with a touch sensor device according to claim 3, wherein said device circuit module further comprises a wired or wireless connection interface to electrically connect to at least one computer equipment.

5. The keyboard having a key-in area integrated with a touch sensor device according to claim 3, wherein said at least one touch sensor device is provided at a key location within said key-in area of said keyboard main body.
